(19) United States
(12) Patent Application Publication
(10) Pub. No.: US 2017/0049180 A1
(43) Pub. Date: Feb. 23, 2017

(54) SELF-GENERATION SHOE USING MAGNETIC INDUCTION

(71) Applicant: BALI TRADING, BUSAN (KR)

(72) Inventor: YUEOBAEK LEE, BUSAN (KR)

(21) Appl. No.: 14/832,435

(22) Filed: Aug. 21, 2015

(51) Int. Cl. A43B 3/00; H02K 35/02; F03G 5/00; H02K 7/18

(52) U.S. Cl. CPC A43B 3/0015; H02K 7/1876; H02K 35/02; F03G 5/00

(57) ABSTRACT

Disclosed herein is a self-generation shoe using magnetic induction. The self-generation shoe includes a self-generation unit which is configured to generate electromotive force using magnetic induction, a rectifier circuit which converts electromotive force generated from the self-generation unit into constant voltage, and a charging circuit which charges the constant voltage output from the rectifier circuit. The self-generation unit includes a coil bobbin and a permanent magnet. The coil bobbin has a hollow pipe structure and protrudes downward from an upper surface of the chamber. A coil is wound around the outer surface of the coil bobbin. The permanent magnet protrudes upward from the lower surface of the chamber and is inserted into or removed from the coil bobbin depending on contraction or expansion of the chamber.

### BACKGROUND OF THE INVENTION

Field of the Invention

The present invention relates generally to self-generation shoes using magnetic induction and, more particularly, to a self-generation shoe using magnetic induction which is configured such that self-generation can be achieved using induction current generated by magnetic induction.

Description of Related Art

Shoes are generally used with the purpose of protecting the feet of users or for decorative purposes. In addition, shoes are used for various other purposes, e.g., for preventing the feet of a user from slipping on or sinking in the ground when walking or working.

Recently, interest in techniques pertaining to shoes for foot health is increasing because of increased interest in health and beauty and because of the development of smart technology and the activation of the health industry, as well as new fields that combine shoes with the IT industry. In particular, a lot of research on techniques for converting kinetic energy, generated when a user walks, into electric energy is being conducted.

Based on the fact that kinetic energy is repeatedly applied to shoes when a user walks, a variety of techniques pertaining to self-generation have been introduced in order to combine various electric functions with shoes.

With regard to techniques pertaining to the self-generation of shoes, piezoelectric elements have been mainly used because an associated device must be installed in the sole of a shoe, which has limited space. However, piezoelectric elements have low durability, and thus a separate metal member is required in order to reinforce the piezoelectric elements. Furthermore, the piezoelectric elements lack practical applicability since they are comparatively expensive. In addition, because the amount of output current generated when a user walks is very small, the application of such a technique using a piezoelectric element is limited only to systems for processing fine output signals, e.g., generating RF signals.

Meanwhile, a self-generator for shoes, which is installed in the sole of a shoe to generate energy, has been proposed. However, the self-generator is comparatively large, and the power transmission mechanism is complex. Therefore, product reliability is reduced, and the problem of noise may be caused.

### SUMMARY OF THE INVENTION

Accordingly, the present invention has been made keeping in mind the above problems occurring in the prior art, and an object of the present invention is to provide a self-generation shoe using magnetic induction which is configured such that generation efficiency can be maximized despite the use of a simple self-generation mechanism, and which has a structure that can reduce the production cost, thus realizing practical applicability.

The object of the present invention is not limited to the above-stated object, and those skilled in the art will clearly understand other objects, not mentioned, from the following description.

In order to accomplish the above object, in an aspect, the present invention provides a self-generation shoe using magnetic induction, including: a self-generation unit provided in a chamber formed in a heel part of a sole of the shoe and configured to generate electromotive force using a magnetic induction phenomenon; a rectifier circuit configured to convert electromotive force generated from the self-generation unit into constant voltage and then output the constant voltage; and a charging circuit unit configured to charge the constant voltage output from the rectifier circuit, wherein the self-generation unit includes: a coil bobbin having a hollow pipe structure and protruding downward from an upper surface of the chamber, with a coil wound around an outer surface of the coil bobbin; and a permanent magnet protruding upward from a lower surface of the chamber, the permanent magnet being inserted into or removed from the coil bobbin in response to contraction or expansion of the chamber.

A shock absorption magnet may be interposed between the upper surface of the chamber and the coil bobbin. The shock absorption magnet may have a polarity equal to that of the permanent magnet. The gauss of the shock absorption magnet is less than that of the permanent magnet.

The coil of the coil bobbin may be wound in alternating directions around respective predetermined sections of the coil bobbin.

In another aspect, the present invention provides a self-generation shoe using magnetic induction, including: a self-generation unit provided in a chamber formed in a heel part of a sole of the shoe and configured to generate electromotive force using a magnetic induction phenomenon; a rectifier circuit configured to convert electromotive force generated from the self-generation unit into constant voltage and then output the constant voltage; and a charging circuit unit configured to charge the constant voltage output from the rectifier circuit, wherein the self-generation unit includes: a partition crossing the chamber and partitioning the chamber into a first chamber and a second chamber disposed below the first chamber, coil bobbins respectively protruding upward and downward from upper and lower surfaces of the partition, each of the coil bobbins having a hollow pipe structure, with a coil wound around an outer surface of the coil bobbin; and permanent magnets respectively protruding toward the partition from an upper surface of the first chamber and a lower surface of the second chamber, the permanent magnets being inserted into or removed from the corresponding coil bobbins in response to contraction or expansion of the chamber.

A shock absorption magnet may be interposed between the partition and each of the coil bobbins. The shock absorption magnet may have a polarity equal to that of the corresponding permanent magnet. The gauss of the shock absorption magnet may be less than that of the corresponding permanent magnet.

The coil of each of the coil bobbins may be wound in alternating directions around respective predetermined sections of the coil bobbin.

In accordance with the present invention, a simple self-generation mechanism using magnetic induction is used. Thereby, power generation efficiency can be maximized. Furthermore, the production cost can be reduced, whereby the practicality is increased.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram illustrating a self-generation shoe using magnetic induction according to an embodiment of the present invention;

FIG. 2 is a perspective view showing in detail the self-generation unit of FIG. 1;

FIG. 3 is a conceptual diagram illustrating a self-generation unit according to a first embodiment of the present invention; and

FIG. 4 is a conceptual diagram illustrating a self-generation unit according to a second embodiment of the present invention.

### DETAILED DESCRIPTION OF THE PREFERRED EMBODIMENTS

The above and other objects, features and advantages of the present invention will be more clearly understood from the following detailed description taken in conjunction with the accompanying drawings. The present invention is not limited to the following embodiments, and various modifications are possible. The embodiments are only for illustrative purposes to enable those skilled in this art to easily understand the scope of the present invention. The terminology used herein is for the purpose of describing particular embodiments only and is not intended to be limiting. As used herein, the singular forms “a,” “an” and “the” are intended to include the plural forms as well, unless the context clearly indicates otherwise.

Hereinafter, exemplary embodiments of the present invention will be described in detail with reference to the attached drawings. Meanwhile, illustration and detailed description of the configuration, operation or effect that can be easily understood by those skilled in the art will be simplified or omitted, and only portions related with the present invention are shown.

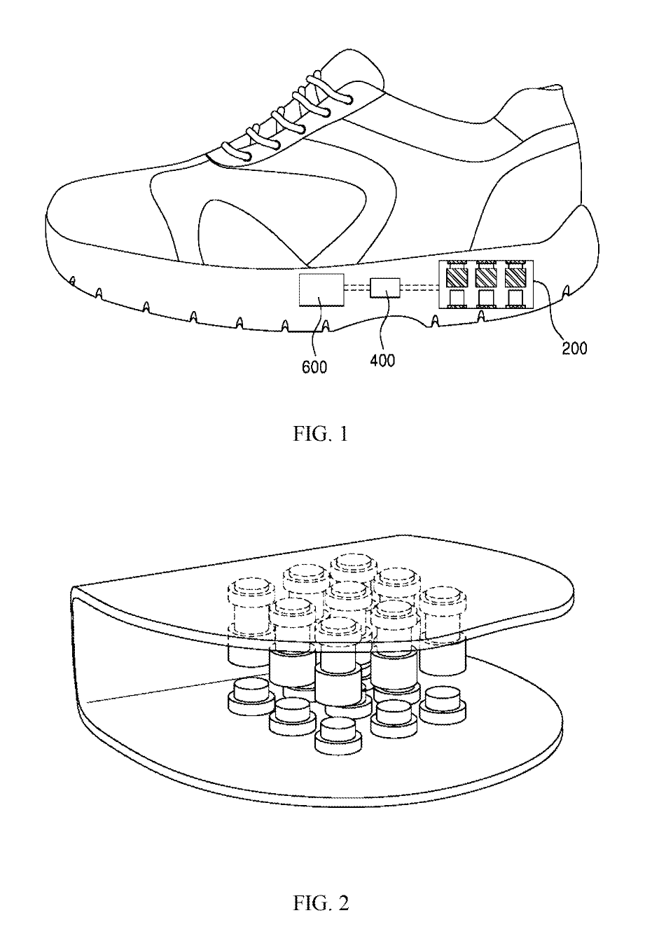

As shown in FIG. 1, a self-generation shoe using magnetic induction according to an embodiment of the present invention includes a self-generation unit 200, which is disposed in a space defined in a heel part of a sole of the shoe and uses magnetic induction to generate electromotive force, a rectifier circuit 400, which converts electromotive force generated from the self-generation unit 200 into constant voltage, and a charging circuit unit 600, which charges voltage output from the rectifier circuit 400.

The configurations of the rectifier circuit 400 and the charging circuit unit 600 are equal to or extremely similar to those of techniques that are typically used in this art, and they can be selectively modified in various forms by those skilled in this art; therefore, a detailed description thereof will be omitted. The self-generation unit 200, which is the essential gist of the present invention, will be described in detail below.

### First Embodiment

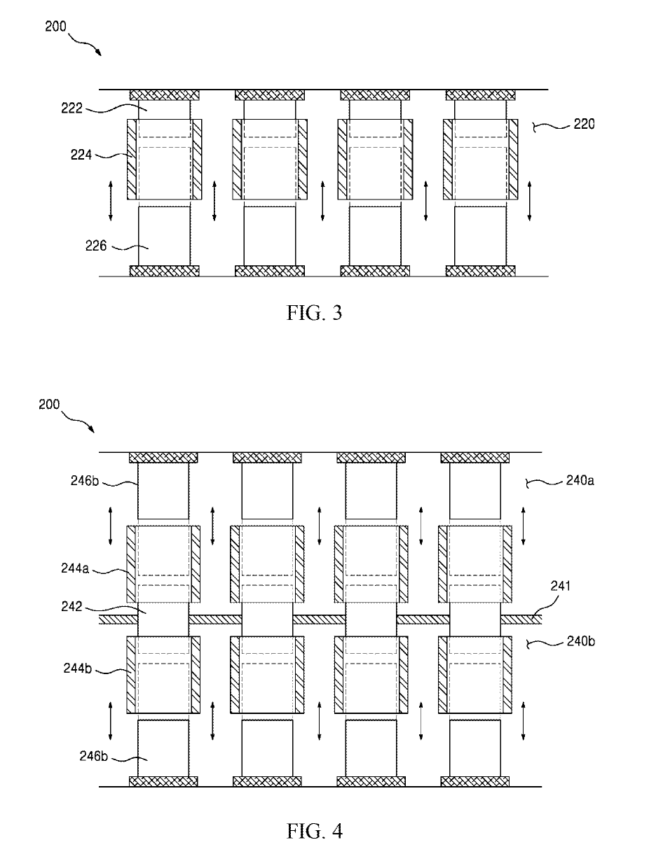

As shown in FIGS. 2 and 3, a self-generation unit 200 according to a first embodiment of the present invention includes a coil bobbin 224 and a permanent magnet 226. The coil bobbin 224 has a hollow pipe structure, protrudes downward from the upper surface of a chamber 220, and is provided with a coil wound around the outer surface of the coil bobbin 224. The permanent magnet 226 protrudes upward from the lower surface of the chamber 220 and is inserted into or removed from the coil bobbin 224 in response to contraction or expansion of the chamber 220.

Here, the chamber 220 is repeatedly contracted and expanded by the application and removal of external force transmitted from the heel of the foot of a user when he/she walks. The permanent magnet 226 is repeatedly inserted into and removed from the coil bobbin 224 by the contraction and expansion of the chamber 220. Therefore, a magnetic induction phenomenon is repeatedly caused, whereby electromotive force is generated from the opposite ends of the coil wound around the coil bobbin 224.

In the self-generation unit 200 having the above-mentioned construction, a plurality of coil bobbins 224 and a plurality of permanent magnets 226 may be disposed in the chamber 220. In this case, the generation efficiency can be enhanced. As such, the self-generation unit 200 has a simple structure, whereby productivity can be enhanced and production costs can be reduced.

Having the same polarity as that of the permanent magnet 226, a shock absorption magnet 222 is interposed between the upper surface of the chamber 220 and the coil bobbin 224. The shock absorption magnet 222 is preferably made of a magnet the size of which is ⅓ of that of the permanent magnet 226. A support, which is formed by injection molding, may be used to fix the shock absorption magnet 222 between the upper surface of the chamber 220 and the coil bobbin 224. When the permanent magnet 226 enters the coil bobbin 224 and approaches the shock absorption magnet 222, a magnetic bearing effect is generated by magnetic repulsive force between the shock absorption magnet 222 and the permanent magnet 226, thus absorbing shocks. At this time, the magnets vibrate relative to each other, so that additional fine voltage can be induced in the coil. Thereby, additional electromotive force is obtained, whereby the generation efficiency can be further enhanced.

It is preferable that the gauss of the shock absorption magnet 222 be much smaller than that of the permanent magnet 226. The reason for this is because of the fact that if the gauss of the shock absorption magnet 222 is greater than that of the permanent magnet 226, the distance that the permanent magnet 226 can move is reduced, and the efficiency with which induction current is generated is thus reduced.

The coil bobbin 224 must be configured such that the coil wound around the coil bobbin 224 is as close to the permanent magnet 226 as possible so that interlinkage magnetic flux, generated when the permanent magnet 226 passes through the coil, can be maintained at the maximum value. Preferably, coils are wound around multiple respective sections of the coil bobbin 224 in alternating directions so as to prevent the coils from interfering with each other. Therefore, induction voltages can be added to each other rather than offsetting each other. The amplitude of induction voltage that is generated when the permanent magnet 226 passes through each junction between the coils of the coil bobbin 224 is about double that of the induction voltage generated when the permanent magnet 226 passes through the inlet end of a first coil or the outlet end of a third coil. A two-cycle induction voltage wave is output. Consequently, the effective value and the output power density of the total induction voltage are greater than twice those of a single coil type.

In addition, the length of each coil may be limited such that the variation in interlinkage magnetic flux in a predetermined space can be increased. Given this, the length of each coil is preferably 1.5 times that of the permanent magnet 226.

Furthermore, the permanent magnet 226 is preferably a neodymium magnet. Neodymium magnets have high magnetic energy production and strong coercive force, thus markedly enhancing the efficiency with which power is generated using magnetic induction. Here, the neodymium magnet is preferably plated with nickel or coated with zinc, urethane, epoxy or the like, as needed, because the corrosion resistance of the neodymium magnet is comparatively low.

### Second Embodiment

As shown in FIG. 4, a self-generation unit according to a second embodiment of the present invention includes a partition 241, coil bobbins 244a and 244b, and permanent magnets 246a and 246b. The partition 241 crosses the chamber so as to partition the chamber into a first chamber 240a and a second chamber 240b, which is formed below the first chamber 240a. The coil bobbins 244a and 244b respectively protrude upward and downward from upper and lower surfaces of the partition 241. Each of the coil bobbins 244a and 244b has a hollow pipe structure and is provided with a coil wound around the outer surface thereof. The permanent magnets 246a and 246b protrude toward the partition 241 from the upper surface of the first chamber 240a and the lower surface of the second chamber 240b, respectively. The permanent magnets 246a and 246b are inserted into or removed from respective coil bobbins 244a and 244b in response to contraction or expansion of the chamber.

In the self-generation unit 200 according to the second embodiment, the coil bobbins 244a and 244b and the permanent magnets 246a and 246b can form a multi-story structure by means of the partition 241. Thereby, power generation efficiency can be increased at least double. Furthermore, the self-generation unit 200 according to the second embodiment can be used in various ways, for example, may be used in high heeled shoes.

Here, the chamber is repeatedly contracted and expanded by the application and removal of external force transmitted from the heel of the foot of a user when he/she walks. The permanent magnets 246a and 246b are respectively and repeatedly inserted into and removed from the coil bobbins 224a and 244b by the contraction and expansion of the chamber. Therefore, a magnetic induction phenomenon is repeatedly caused, whereby electromotive force is generated from the opposite ends of the coils wound around the coil bobbins 244a and 244b.

The self-generation unit 200 according to the second embodiment having the multi-story structure may be configured such that a plurality of coil bobbins 244a and a plurality of permanent magnets 246a are disposed in the first chamber 240a and a plurality of coil bobbins 244b and a plurality of permanent magnets 246b are disposed in the second chamber 240b. In this case, generation efficiency can be further enhanced. As such, the self-generation unit 200 has a simple structure, so that productivity can be enhanced and production costs can be reduced.

Meanwhile, a shock absorption magnet 242 is interposed between the partition 241 and each coil bobbin 244a, 244b. Each shock absorption magnet 242 has the same polarity as that of the corresponding permanent magnet 245a, 246b. The shock absorption magnet 242 is preferably made of a magnet the size of which is ⅓ of that of the corresponding permanent magnet 246a, 246b. A support, which is formed by injection molding, may be used to fix the shock absorption magnet 222 between the partition 241 and the corresponding coil bobbin 244a, 244b. When each permanent magnet 246a, 246b enters the corresponding coil bobbin 244a, 244b and approaches the shock absorption magnet 242, a magnetic bearing effect is generated by the magnetic repulsive force between the shock absorption magnet 242 and the permanent magnet 246a, 246b, thus absorbing the shock. At this time, the magnets vibrate relative to each other, so that additional fine voltage can be induced in the coil. Thereby, additional electromotive force is obtained, whereby the generation efficiency can be further enhanced.

It is preferable that the gauss of each shock absorption magnet 242 be much smaller than that of the corresponding permanent magnet 246a, 246b. The reason for this is because of the fact that if the gauss of the shock absorption magnet 242 is greater than that of the corresponding permanent magnet 246a, 246b, the distance that the permanent magnet 242 can move is reduced, thereby reducing the efficiency with which induction current is generated.

Each coil bobbin 244a, 244b must be configured such that the coil wound around the coil bobbin 244a, 244b is as close to the corresponding permanent magnet 246a, 246b as possible so that interlinkage magnetic flux generated when the permanent magnet 246a, 246b passes through the coil can be maintained at the maximum value. Preferably, coils are wound around multiple respective sections of the coil bobbin in alternating directions so as to prevent the coils from interfering with each other. Therefore, induction voltages can be added to each other rather than offsetting each other. The amplitude of induction voltage that is generated when the permanent magnet 246a, 246b passes through each junction between the coils of the coil bobbin 224a, 224b is about double that of the induction voltage generated when the permanent magnet 246a, 246b passes through the inlet end of a first coil or the outlet end of a third coil. A two-cycle induction voltage wave is output. Consequently, the effective value and the output power density of the total induction voltage are more than double those of a single coil type.

In addition, the length of each coil may be limited such that the variation of interlinkage magnetic flux in a predetermined space can be increased. Given this, the length of each coil is preferably 1.5 times that of the corresponding permanent magnet 246a, 246b.

Furthermore, each permanent magnet 246a, 246b is preferably made of a neodymium magnet. Neodymium magnets have high magnetic energy product and strong coercive force, thus markedly enhancing the efficiency with which power is generated using magnetic induction. Here, the neodymium magnet is preferably plated with nickel or coated with zinc, urethane, epoxy or the like, as needed, because the corrosion resistance of the neodymium magnet is comparatively low.

As described above, in accordance with the present invention, a simple self-generation mechanism using magnetic induction is used. Thereby, power generation efficiency can be maximized. Furthermore, production costs can be reduced, whereby the practicality is increased.

The above descriptions are supposed to describe the features and technical advantages in wider ranges in an attempt to help better understand the accompanying claims. Although the exemplary embodiments of the present invention have been disclosed, those skilled in the art will appreciate that various modifications, additions and substitutions are possible, without departing from the scope and spirit of the invention as disclosed in the accompanying claims. Therefore, it should be understood that the exemplary embodiments are only for illustrative purposes and do not limit the bounds of the present invention. It is intended that the bounds of the present invention be defined by the accompanying claims, and various modifications, additions and substitutions, which can be derived from the scope and equivalent concepts of the accompanying claims, fall within the bounds of the present invention.

What is claimed is:

1. A self-generation shoe using magnetic induction, comprising: a self-generation unit provided in a chamber formed in a heel part of a sole of the shoe and configured to generate electromotive force using a magnetic induction phenomenon; a rectifier circuit configured to convert electromotive force generated from the self-generation unit into constant voltage and then output the constant voltage; and a charging circuit unit configured to charge the constant voltage output from the rectifier circuit,
wherein the self-generation unit comprises:
a coil bobbin having a hollow pipe structure and protruding downward from an upper surface of the chamber, with a coil wound around an outer surface of the coil bobbin; and
a permanent magnet protruding upward from a lower surface of the chamber, the permanent magnet being inserted into or removed from the coil bobbin in response to contraction or expansion of the chamber.

2. The self-generation shoe as set forth in claim 1, wherein a shock absorption magnet is interposed between the upper surface of the chamber and the coil bobbin, the shock absorption magnet having a polarity equal to a polarity of the permanent magnet.

3. The self-generation shoe as set forth in claim 2, wherein a gauss of the shock absorption magnet is less than a gauss of the permanent magnet.

4. The self-generation shoe as set forth in claim 1, wherein the coil of the coil bobbin is wound in alternating directions around respective predetermined sections of the coil bobbin.

5. A self-generation shoe using magnetic induction, comprising: a self-generation unit provided in a chamber formed in a heel part of a sole of the shoe and configured to generate electromotive force using a magnetic induction phenomenon; a rectifier circuit configured to convert electromotive force generated from the self-generation unit into constant voltage and then output the constant voltage; and a charging circuit unit configured to charge the constant voltage output from the rectifier circuit,
wherein the self-generation unit comprises:
a partition crossing the chamber and partitioning the chamber into a first chamber and a second chamber disposed below the first chamber;
coil bobbins respectively protruding upward and downward from upper and lower surfaces of the partition, each of the coil bobbins having a hollow pipe structure, with a coil wound around an outer surface of the coil bobbin; and
permanent magnets respectively protruding toward the partition from an upper surface of the first chamber and a lower surface of the second chamber, the permanent magnets being inserted into or removed from the corresponding coil bobbins in response to contraction or expansion of the chamber.

6. The self-generation shoe as set forth in claim 5, wherein a shock absorption magnet is interposed between the partition and each of the coil bobbins, the shock absorption magnet having a polarity equal to a polarity of the corresponding permanent magnet.

7. The self-generation shoe as set forth in claim 6, wherein a gauss of the shock absorption magnet is less than a gauss of the corresponding permanent magnet.

8. The self-generation shoe as set forth in claim 5, wherein the coil of each of the coil bobbins is wound in alternating directions around respective predetermined sections of the coil bobbin.
